(19) United States
(12) Patent Application Publication
(10) Pub. No.: US 2002/0195870 A1
(43) Pub. Date: Dec. 26, 2002

(54) Trailer braking system

(76) Inventors: Thomas L. Brunson, Barnsville, GA (US); Thomas A. McKenzie, Spring Lake, MI (US)

Correspondence Address: SAND & SEBOLT, 4801 DRESSLER RD., N.W., SUITE 194, CANTON, OH, 44718, US

(21) Appl. No.: 10/151,786

(22) Filed: May 20, 2002

Related U.S. Application Data
(60) Provisional application No. 60/292,362, filed on May 21, 2001.

(51) Int. Cl. B60T 7/20

(52) U.S. Cl. 303/7; 303/123

(57) ABSTRACT

A trailer braking system includes a controller that supplies pressurized air or hydraulic fluid to an actuator that powers a master brake cylinder on the trailer. A pressure sensor is supplied to provide feedback to the controller so that the controller may vary the braking force being generated by the system. The trailer braking system includes an indicator system that allows the driver of the vehicle towing the trailer to readily determine the status of the trailer braking system.

### CROSS REFERENCE TO RELATED APPLICATIONS

This application claim priority from U.S. Provisional Application Serial No. 60/292,362 filed May 21, 2001; the disclosures of which are incorporated herein by reference.

### BACKGROUND OF THE INVENTION

1. TECHNICAL FIELD

The present invention generally relates to trailer braking systems and, more particularly, to trailer braking systems that work in cooperation with the braking system of the vehicle towing the trailer. Specifically, the present invention relates to a trailer braking system that is pneumatically or hydraulically controlled and includes a feedback system that compares the braking force created by the trailer to the braking force being created in the vehicle towing the trailer.

2. BACKGROUND INFORMATION

Typical large trailers which form the rear portion of the combination commonly referred to as a tractor-trailer vehicle include braking systems that are powered by the braking system of the tractor. These brakes are typically air-powered brakes and are actuated with pressurized air supplied by the tractor. These braking systems have been used for many years and have evolved to the point where they are extremely reliable and are capable of stopping large loads in relatively short distances. Although air-powered trailer braking systems are effective, they are not used on small trailers because the vehicles commonly towing smaller trailers are not equipped with the air compressors and connectors to power an air braking system.

Most small trucks, SUVs, and large cars that are used to tow small trailers used hydraulically-actuated brakes. These vehicles are not equipped with hydraulic lines that extend to the rear of the vehicle that could be connected to a hydraulic trailer braking system. Even if such lines were provided, hydraulic connections between a tow vehicle and a trailer would be undesirable. For these reasons, trailer braking systems have used different actuators to create trailer braking force when braking force is being generated by the vehicle towing the trailer. Different types of these actuators are described in the Background of the Invention section of U.S. Pat. No. 5,806,937 and a different system is described and claimed in U.S. Pat. No. 5,806,937. Although these devices are functional, room for improvement remains in the art.

### BRIEF SUMMARY OF THE INVENTION

The invention provides a trailer braking system that actuates the brakes of a trailer in response to braking force being generated by the vehicle towing the trailer. The trailer braking system of the invention monitors the magnitude of the force generated by the vehicle towing the trailer and generates a corresponding force in the trailer brakes.

The invention provides a system that creates the braking force with either a hydraulic or pneumatic actuator. The force generated by this actuator may be altered with a lever.

The present invention also provides an indication system that allows the driver of the vehicle towing the trailer to easily determine the status of the trailer braking system. The indication system allows the driver to determine the status while the vehicle and trailer are moving on the road.

### BRIEF DESCRIPTION OF THE SEVERAL VIEWS OF THE DRAWINGS

FIG. 1 is a side view of a vehicle and a trailer showing the braking systems of the vehicle and trailer schematically.

FIG. 2 is a schematic view of a first embodiment of the trailer braking system of the present invention.

FIG. 3 is a view similar to FIG. 2 showing braking force being applied by the system.

FIG. 4 is a view similar to FIG. 2 showing an alternative embodiment of the trailer braking system of the invention.

FIG. 5 is a schematic view showing an alternative version of the trailer braking system of the invention.

FIG. 6 is a schematic view of an alternative version of the trailer braking system of the present invention.

FIG. 7 is a view similar to FIG. 6 showing the trailer braking system applying a braking force.

FIG. 8 is a schematic view of an alternative version of the trailer braking system of the present invention.

Similar numbers refer to similar parts throughout the specification.

### DETAILED DESCRIPTION OF THE INVENTION

The first embodiment of the trailer braking system of the present invention is indicated generally by the numeral 10 in the accompanying drawings. Trailer braking system 10 is designed to create braking force in a trailer 12 by supplying the force that actuates brakes 14 and 16. Trailer 12 also includes a body 18 and wheels 20. Body 18 of trailer 12 may be a flat trailer, a horse trailer, a box trailer, or any of the variety of other trailers known in the art.

Trailer 12 is towed by a vehicle 22 that includes a braking system 24. Braking system 24 includes a brake pedal 26 and brakes 28 that are operated when pedal 26 is depressed. The remaining elements of brake system 24 are known to those skilled in the art.

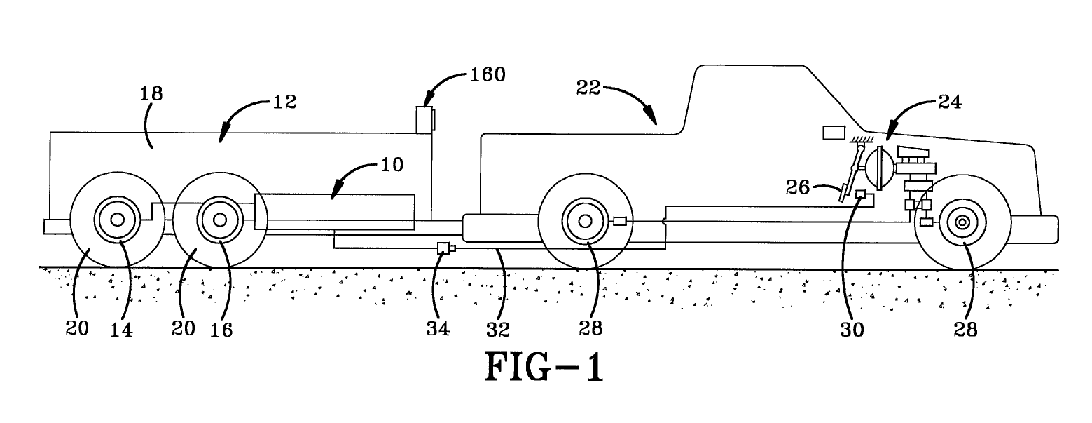

Brake system 10 includes a control unit having a control device 30 positioned with vehicle 22 to sense when brake system 24 is actuated by the driver of vehicle 22. Control device 30 may be positioned adjacent brake pedal 26 to sense the physical movement of pedal 26. Control device 30 may also be a sensor that is adapted to sense the amount of hydraulic pressure being delivered to brakes 28 by system 24. Other types of control devices 30 may be used that are known to those skilled in the art as long as devices 30 are adapted to sense when brake system 24 of vehicle 22 is applied. In accordance with another feature of the invention, the tow vehicle and brake controller and control device 30 may also sense the magnitude of the braking force being generated by system 24. In this embodiment, device 30 provides an output signal proportional to some measured vehicle 22 condition such as braking force, deceleration, or hydraulic pressure. The signal created by control device 30 is communicated to system 10 by way of a direct wire 32 as depicted in FIG. 1 or by radio signal. When wire 32 is used, a plug 34 is typically provided to allow trailer 12 to be disconnected from vehicle 22.

System 10 generally includes a controller 40 that communicates with control device 30 to actuate system 10. Controller 40 also regulates system 10 to control the amount of braking force that is generated by system 10. Controller 40 may be any of a variety of devices or combination of devices known to those skilled in the art. Controller 40 may include a power source such as a battery or may be powered by electricity delivered to controller 40 by wire 32. Controller 40 may include a central processing unit (CPU) and a memory device that allows instructions to be stored on controller 40 that are executed by the CPU.

Controller 40 is connected to first 42 and second 44 valves that may be selectively opened and closed by electrical signals sent from controller 40. Valves 42 and 44 may be solenoid valves and, more particularly, may be large orifice solenoid valves. First valve 42 is normally closed while at rest with second valve 44 is normally open while at rest.

First valve 42 is operatively positioned between a supply of pressurized air 46 and a pneumatic brake actuator 48. Second valve 44 is operatively positioned between brake actuator 48 and the atmosphere so that second valve 44 will vent brake actuator 48 when second valve 44 is opened to the atmosphere.

Supply of pressurized air 46 may include an air compressor 50 that is battery powered or powered by electricity delivered by line 32. Supply 46 may also include a reservoir tank 52 that stores pressurized air so that compressor 50 does not have to continuously run while using system 10. In the embodiment of the invention depicted in the drawings, compressor 50 is connected to tank 52 by a first air line 54 and supply 46 is connected to first valve 42 by a second air line 56. A pressure sensor 58 is in communication with the pressurized air supplied to first valve 42 by a third air line 60 so that controller 40 can determine if the air compressor should operate to restore air pressure to reservoir tank 52. Pressure sensor 58 is thus also in communication with controller 40. A pressure switch may be installed at compressor 50 to control the function or operation of compressor 50. When supply air pressure falls below a prescribed level (cut-in pressure), compressor is energized and increases the supply pressure in reservoir 52 until it reaches a predetermined upper limit (cut-out pressure) or maximum level at which the unit is de-energized (no longer pumps).

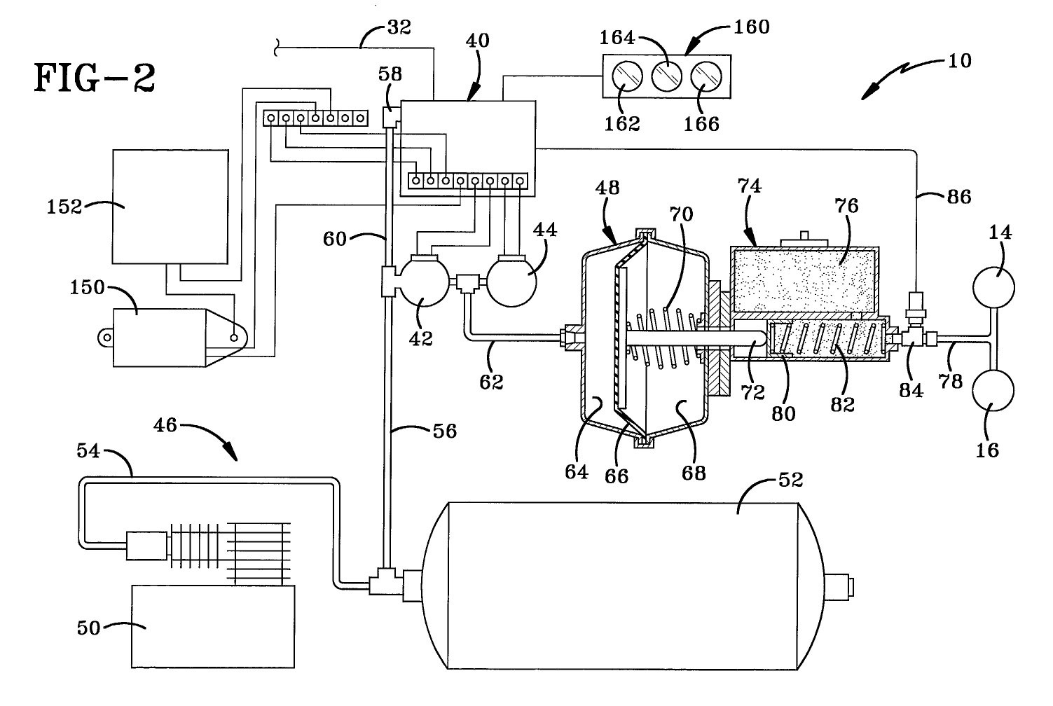

A fourth air line 62 connects valves 42 and 44 with the pneumatic chamber 64 of brake actuator 48. A flexible diaphragm 66 separates pressure chamber 64 from a return chamber 68 inside of brake actuator 48. A spring 70 is disposed within chamber 68 to force diaphragm 66 back to the resting position as depicted in FIG. 2. A push rod assembly 72 is acted upon by diaphragm 66 and extends out of brake actuator 48 into master cylinder 74.

Master cylinder 74 includes a reservoir 76 that holds hydraulic fluid. Reservoir 76 is in fluid communication with hydraulic brake lines 78 that extends to brakes 14 and 16. Master cylinder 74 includes a piston 80 that is slidably disposed within master cylinder 74. A return spring 82 engages piston 80 to force it to the resting or unactuated position depicted in FIG. 2.

System 10 includes a hydraulic pressure sensor 84 that is adapted to sense the hydraulic pressure in brake lines 78 and create a signal that corresponds with the magnitude of this pressure and thus the amount of braking force supplied to brakes 14 and 16. The signal from sensor 84 is communicated to controller 40 with a feedback line 86.

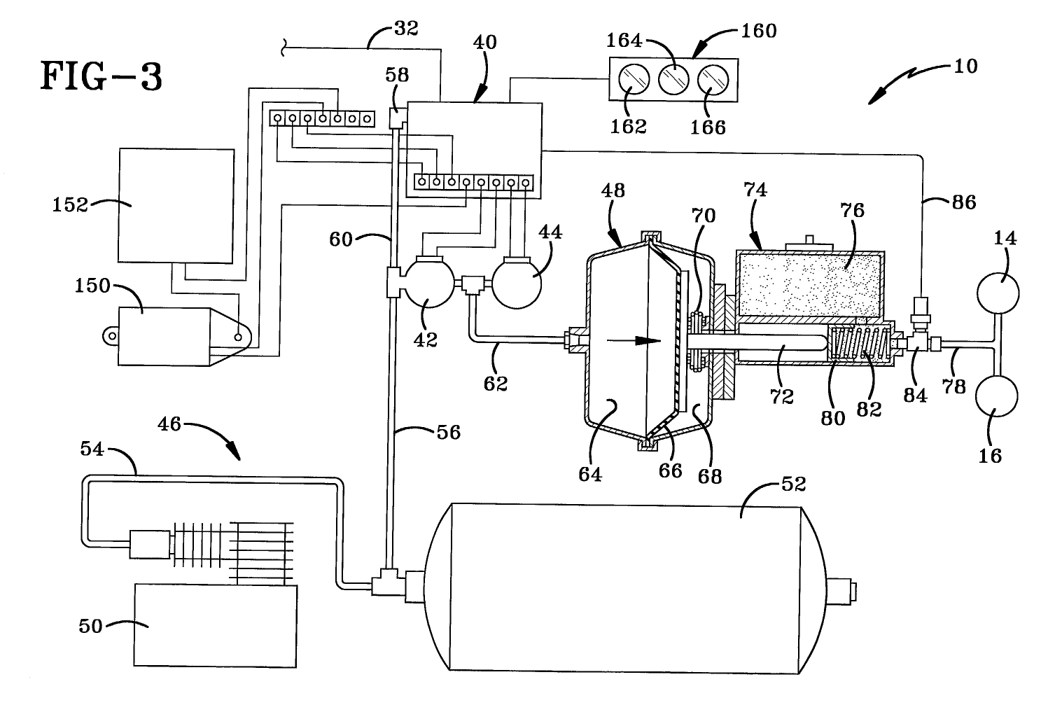

System 10 functions by sensing when brake system 24 of vehicle 22 has been actuated when the signal from control device 30 is received by controller 40. Controller 40 then sends a signal to first valve 42 causing it to open and a signal to second valve 44 causing it to close. This configuration allows pressurized air from supply 46 to travel through fourth air line 62 to brake actuator 48 where it applies pressure against diaphragm 66 causing it to move rod 72. This configuration is depicted in FIG. 3.

When brake actuator 48 is exposed to pressurized air through fourth air line 62, piston 80 is moved to compress the hydraulic fluid in master cylinder 74 to deliver hydraulic braking force to brakes 14 and 16. Sensor 84 monitors the hydraulic pressure delivered to brakes 14 and 16 and relays the magnitude of the pressure signal to controller 40. Controller 40 compares the magnitude of the hydraulic braking pressure signal generated by master cylinder 74 to the magnitude of the braking pressure signal being delivered by control device 30.

Controller 40 compares the magnitude of the feedback signal from sensor 84 with the signal being delivered to controller 40 from control device 30. When the differential between these signals is 0 or within a small prescribed amount, controller 40 closes first valve 42 to interrupt the flow of pressurized air to brake actuator 48. This maintains the desired amount of pressure on master cylinder 74 and keeps the braking pressure generated by system 10 substantially equal to the braking force being requested by system 24. When the magnitude of the signal delivered by control device 30 drops below the magnitude of the signal 20 created by sensor 84, controller 40 opens second valve 44 to relieve pressure from brake actuator 48 to decrease the hydraulic pressure in brake lines 78. Second valve 44 is configured to rapidly vent the pressure from brake actuator 48 so that brakes 14 and 16 do not remain applied when the driver of vehicle 22 releases brake pedal 26. Spring 70 returns diaphragm 66 to the resting position of FIG. 2 and system 10 is ready to be used again. If a significant amount of air has been depleted from tank 52, compressor 50 includes a pressure switch adapted to activate compressor 50 to refill tank 52.

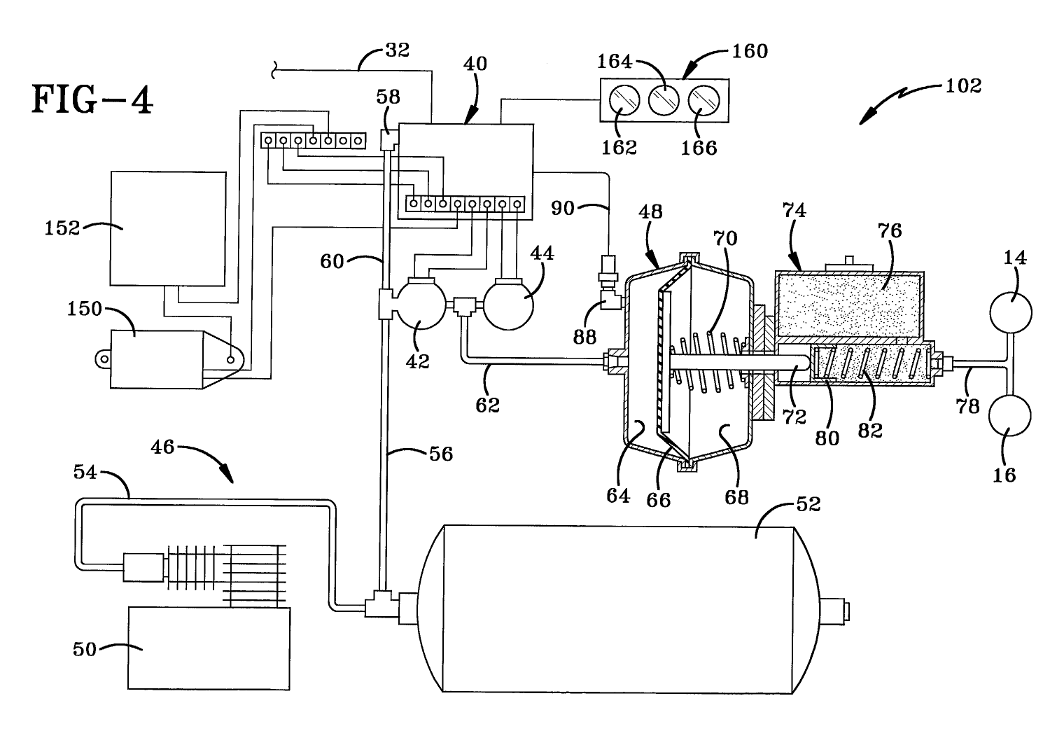

An alternative embodiment of the trailer braking system of the invention is indicated generally by the numeral 102 in FIG. 4. In this embodiment, a pneumatic pressure sensor 88 is adapted to sense the air pressure in brake actuator 48 and report the magnitude of this pressure back to controller 40 by feedback wire 90. System 102 thus functions similar to system 10 except that controller 40 is using the actuation air pressure delivered to or disposed within brake actuator 48 to create the feedback signal.

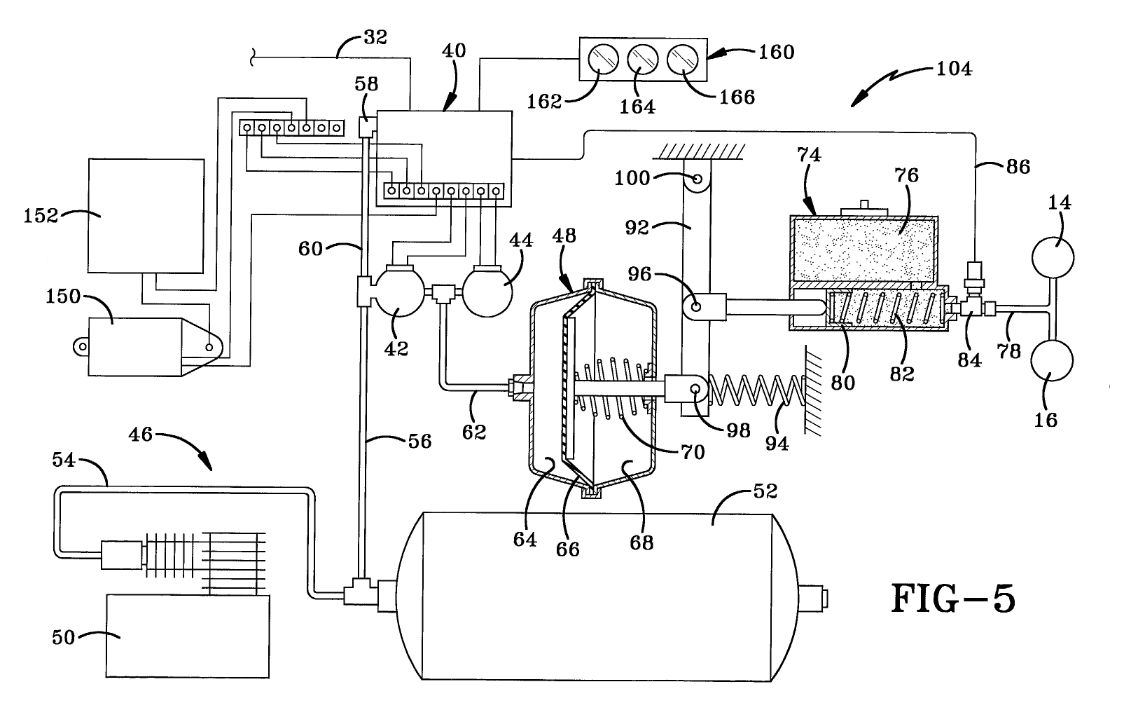

Another alternative embodiment of the trailer braking system of the present invention is indicated generally by the numeral 104 in FIG. 5. System 104 is similar to system 10 except that a lever 92 is disposed intermediate master cylinder 74 and brake actuator 48 so that the force delivered by brake actuator 48 may be modified before it is delivered to master cylinder 74. An additional return spring 94 may be provided to help spring 70 return diaphragm 66 and lever 92 back to the resting position depicted in FIG. 5. In FIG. 5, the pivot point 96 between lever 92 and master cylinder 74 is disposed along lever 92 between the pivot point 98 where lever 92 connects with brake actuator 48 and the pivot point 100 where lever 92 pivots with respect to ground (a fixed component of trailer 12). In other embodiments of the invention, pivot point 98 may be disposed intermediate pivot points 96 and 100 to alter the force delivered to master cylinder 74. Those skilled in the art will recognize that pivot point 96 may be moved along the longitudinal length of lever 92 to vary the force generated by brake actuator 48 as necessary. Those skilled in the art will also recognize that spring 94 is optional and may be removed.

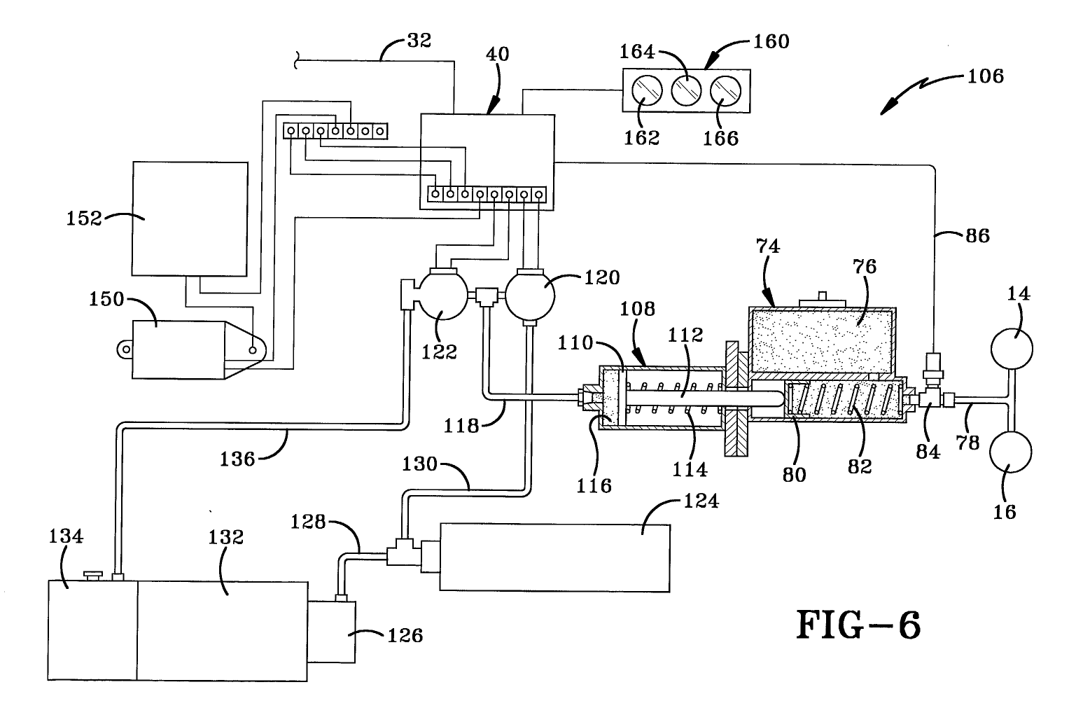

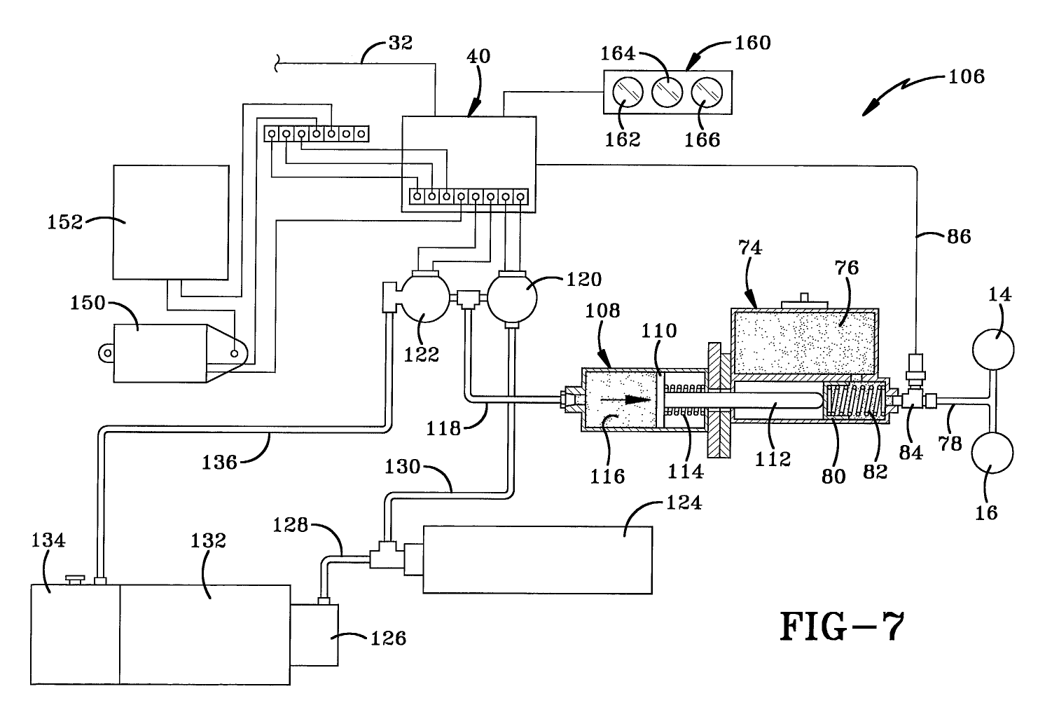

Another alternative embodiment of the trailer braking system of the present invention is indicated generally by the numeral 106 in FIGS. 6 and 7. In this embodiment, master brake cylinder 74 is actuated by a hydraulic actuator 108 instead of the pneumatic brake actuator 48 described above. Hydraulic actuator 108 includes a piston 110, a push rod 112, and a return spring 114. Actuator 108 is positioned so that push rod 112 engages piston 80 of master brake cylinder 74 to deliver hydraulic force to brakes 14 and 16. Hydraulic actuator 108 includes a chamber 116 disposed adjacent piston 110 for receiving hydraulic fluid from a fluid supply line 118.

System 106 includes first 120 and second 122 valves that control the delivery of hydraulic fluid through system 106. First valve 120 is disposed intermediate supply line 118 and a hydraulic accumulator 124. Hydraulic accumulator 124 may be a piston or bladder-type accumulator. A hydraulic pump 126 is in fluid communication with accumulator 124 so that hydraulic fluid may be delivered from pump 126 to accumulator 124 by a first supply line 128. A second supply line 130 extends between accumulator and/or pump 126 and first valve 120. An electric motor 132 is associated with pump 126 to drive pump 126. A hydraulic fluid reservoir 134 is provided to hold hydraulic fluid that is needed by pump 126 and returned by second valve 122. A return line 136 is provided intermediate second valve 122 and hydraulic fluid reservoir 134 so that fluid may be returned to reservoir 134 for pump 126.

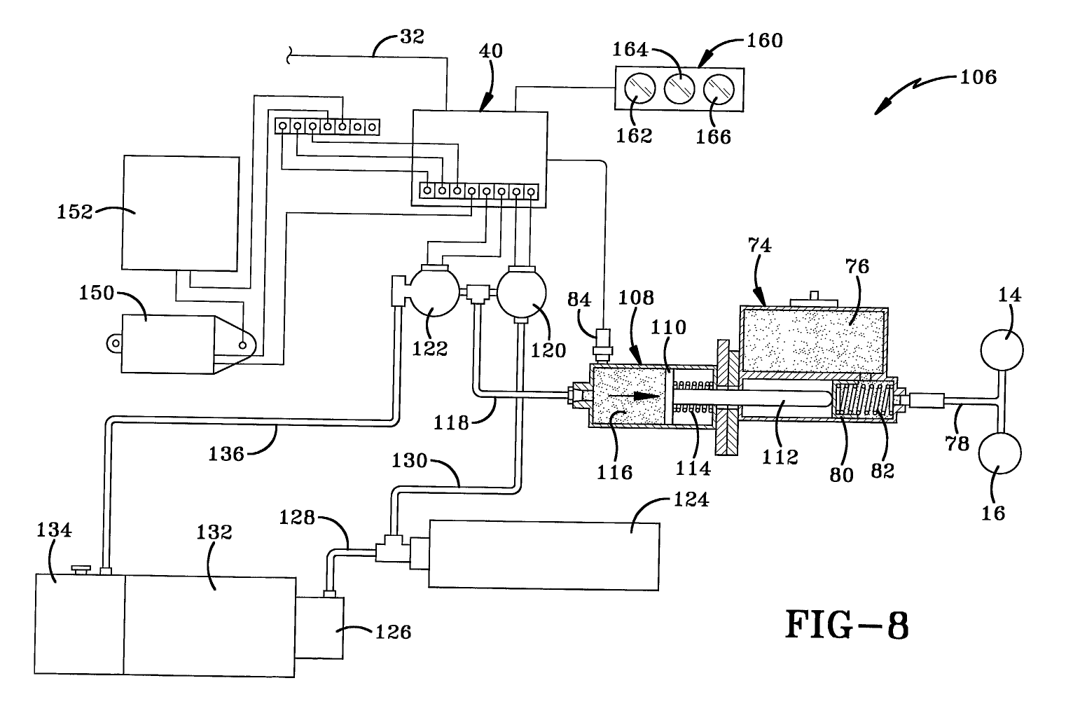

System 106 functions similar to system 10 described above except that hydraulic fluid is not vented to the atmosphere when pressure is to be relieved on hydraulic actuator 108. Instead of venting the pressure to the atmosphere, second valve 122 is opened and the pressurized fluid returns to fluid reservoir 134. When brake force pressure is to be applied, controller 40 causes valve 122 to close and causes first valve 120 to open. Controller 40 may also actuate electric motor 132 and pump 126 to maintain adequate hydraulic pressure in hydraulic accumulator 124 in system 106. When valve 120 is initially opened, pressure from accumulator 124 is delivered to hydraulic actuator 108 to create braking pressure in master cylinder 74. This condition is depicted in FIG. 7. Sensor 84 provides feedback through line 86 as described above so that controller 40 may create braking pressure in brakes 14 and 16 that corresponds with the braking force being generated by vehicle 22. FIG. 8 shows an alternative embodiment wherein sensor 84 provides feedback based on the pressure in the hydraulic actuator.

In each of the embodiments described above, a break away switch 150 is provided so that the system may be activated to create braking force if vehicle 22 becomes separated from trailer 12. Break away switch 150 may be powered by a battery 152 that supplies power to switch 150 and powers controller 40 and the remaining elements of the system that need power during a break away event. Break away switch 150 is configured to sense when trailer 12 has been separated from vehicle 22. Break away switch 150 may sense this event in a variety of different manners known in the art. In one embodiment, a physical wire may be connected between vehicle 22 and trailer 12 that activates switch 150 when the wire is broken. The wire may be a component of plug 34 or may be a separate wire extending between the two. In another embodiment, the wire is connected directly to switch 150 and pulls a component on switch 150 when the wire is tugged by vehicle 22 as it separates from trailer 12. In another embodiment, switch 150 is configured to sense a change in the electronic signal that is continuously delivered to switch 150 by control device 30. Any of a variety of different embodiments may also be used with the invention. When switch 150 is activated, controller 40 functions to apply full braking force to master cylinder 74 regardless of the feedback received from the system. Switch 150 thus overrides the comparison mechanism of controller 40 during a break away event.

Each of the systems of the invention may also include a diagnostic or warning indicator 160 that allows the driver of vehicle 22 to quickly and accurately determine the status of the trailer braking system. In one embodiment, indicator 160 may include first 162, second 164, and third 166 lights that are visible to the user of the system. In FIG. 1, indicator 160 is shown as being in a position where the driver of vehicle 22 may view lights 162, 164, and 166 through the rear window of vehicle 22. Indicator 160 may also be in other positions on trailer 12 or vehicle 22 without departing from the concepts of the present invention.

During normal operation of the trailer braking system, first light 162 will always be illuminated indicating that the trailer braking system is operational. If none of the lights of indicator 160 are illuminated, the user of the system will know to check the bulb filaments or to check the operation of the trailer braking system.

Indicator 160 is configured to light first light 162 if controller 40 and compressor 50 or pump 126 has power. Light 162 may also be lit only if tank 52 or accumulator 124 is pressurized. Light 162 will also only be lit if actuator 48 or 108 is in the resting position. Light 162 thus indicates that brakes 14 and 16 are not applied.

Light 164 will be lit if pressure in tank 52 or accumulator 124 has fallen below a lower level. However, light 164 will be lit only if compressor 50 is energized and operating or pump 126 is energized and operating to replace the pressure.

Light 166 will only light if the air pressure in tank 52 or the hydraulic pressure in accumulator 124 have fallen below a predetermined safety level where the system will not develop significant braking force in brakes 14 and 16. The driver of vehicle 22 will thus readily determine if the trailer braking system will operate normally and create as much brake force as the operator needs. Second light 164 tells the operator of the vehicle that the trailer braking system is recharging and that some brake force is available. If third light 166 is on and is on at the same time as second light 164, the operator of vehicle 22 should proceed with caution because he knows that the trailer braking system will not generate significant forces in brakes 14 and 16 of trailer 12. If third light 166 is on and second light 164 is off, the operator of vehicle 22 knows that the trailer braking system is dysfunctional.

In another embodiment, indicator 160 may include only a single light 162 that is visible to the driver of the vehicle. During normal operation of the trailer braking system when the brakes are not applied, light 162 is illuminated indicating that the trailer braking system is operational. This arrangement provides a direct check on the filament of light 162, provides a direct check on the power supply to the tow vehicle, provides a direct functional check on the signal line between the two vehicles, and provides an indication that the pneumatic (or hydraulic) supply system is adequately charged to allow the brake system to function when requested by the driver of the tow vehicle. If any of these conditions are not met, light 162 will not illuminate when the brakes are not illuminated. This tells the driver to check the system before operating.

In the single lamp embodiment, light 162 will flash when the brakes are being applied to indicate that the trailer braking system is creating braking force. The flashing will occur when the feedback signal is detected. If the light is not flashing, the user recognizes that a problem exists and that the ser should check the system.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. A trailer braking system for generating braking force in the brakes of a trailer that is being towed by a vehicle having a braking system; the trailer braking system comprising:
a control device adapted to create a signal when the braking system of the vehicle towing the trailer is actuated;
a source of pressurized fluid;
a first valve connected to the source of pressurized fluid;
a fluid actuator movable between actuated and unactuated positions;
a second valve connected to the fluid actuator; the second valve adapted to move the actuator to the unactuated position;
a controller in communication with the control device, the first valve, and the second valve;
a master cylinder adapted to generate hydraulic braking force in the brakes of the trailer;
the master cylinder being applied when the fluid actuator is in the actuated position;
the master cylinder being unactuated when the fluid actuator is in the unactuated position; and
a feedback sensor in communication with the controller; the feedback sensor capable of generating a signal that represents the braking force generated by the master cylinder.

2. The system of claim 1, wherein the controller compares the signal from the feedback sensor to the signal from the control device.

3. The system of claim 2, wherein the signal created by the control device includes a component that represents the magnitude of the braking force being generated in the vehicle towing the trailer.

4. The system of claim 1, wherein the source of pressurized fluid includes an air compressor.

5. The system of claim 4, wherein the source of pressurized fluid further includes an air tank.

6. The system of claim 1, further comprising a break away switch adapted to move the fluid actuator to the actuated position when the trailer breaks away from the vehicle towing the trailer.

7. The system of claim 1, further comprising an indicator having first, second, and third lights; the indicator being in communication with the controller.

8. The system of claim 7, wherein the first light is lit when the system is ready for operation.

9. The system of claim 8, wherein the second light is lit when the source of pressurized fluid is operating.

10. The system of claim 9, wherein the third light is lit when the system does not have enough power to create braking force.

11. The system of claim 1, wherein the feedback sensor senses the hydraulic pressure generated by the master cylinder.

12. The system of claim 1, wherein the feedback sensor senses the pressure in the fluid actuator.

13. The system of claim 1, wherein the source of pressurized fluid includes a hydraulic pump.

14. The system of claim 13, wherein the source of pressurized fluid includes a hydraulic accumulator.

15. The system of claim 1, further comprising an indicator having a first light adapted to be viewed by the driver of the vehicle.

16. The system of claim 15, wherein the first light is lit when the system is ready for operation.

17. The system of claim 16, wherein the first light flashes when the system is operating.

18. A method of generating braking force in a trailer having brakes; the trailer being towed by a vehicle having a braking system; the method comprising the steps of:
sensing the actuation of the braking system of the vehicle towing the trailer;
supplying pressurized fluid to an actuator to move the actuator to an actuated position;
generating trailer braking force in response to the actuated position of the actuator;
sensing the trailer braking force;
comparing the trailer braking force with the braking force of the vehicle towing the trailer; and
adjusting the trailer braking force in response to the comparison.

19. A trailer braking system for generating braking force in the brakes of a trailer that is being towed by a vehicle having a braking system; the trailer braking system comprising:
a control device adapted to create a signal when the braking system of the vehicle towing the trailer is actuated;
a source of pressurized fluid;
a first valve connected to the source of pressurized fluid;
a fluid actuator movable between actuated and unactuated positions;
a second valve connected to the fluid actuator; the second valve adapted to move the actuator to the unactuated position;
a controller in communication with the control device, the first valve, and the second valve;
a master cylinder adapted to generate hydraulic braking force in the brakes of the trailer;
the master cylinder being applied when the fluid actuator is in the actuated position;
the master cylinder being unactuated when the fluid actuator is in the unactuated position; and
a feedback sensor in communication with the controller; the feedback sensor capable of generating a signal that represents the braking force generated by the master cylinder.
